(19) United States
(12) Patent Application Publication
(10) Pub. No.: US 2005/0135401 A1
(43) Pub. Date: Jun. 23, 2005

(54) Multicast message routing systems and methods

(76) Inventor: Michael Schmidt, Zionsville, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/740,168

(22) Filed: Dec. 18, 2003

(51) Int. Cl. H04J 3/26

(52) U.S. Cl. 370/432

(57) ABSTRACT

A computer system and method is disclosed that includes a notification application that receives requests from clients for multicast messages over a point-to-point connection, provides a response to the client over the point-to-point connection regarding how the client should listen for the multicast messages, and improves multicast message delivery reliability by using point-to-point communication in conjunction with multicast. A computer system and method is disclosed that includes a notification application that serves as a central hub for data transport between clients or components on the network, and that routes messages to clients using multicast when available and unicast when multicast is not available.

### BACKGROUND OF THE INVENTION

The present invention relates broadly to the field of computer networks, and more particularly, but not exclusively, relates to multicasting techniques.

There are two network protocols commonly used for transporting messages in a network. The most common approach is to use a point-to-point (unicast) protocol, such as TCP/IP. With point-to-point, one process on one machine communicates with another process on another machine or a different machine. The communication appears as two streams of data: one stream carries the data from one process to the other, while the other carries data in the other direction. Point-to-point communications are very reliable, because of the direct connection between the two processes. However, point-to-point communications also increase network traffic. The reason for an increase in network traffic is because when point-to-point communications are used, the nodes of a network can only send to one other node at a time. If a node wants to send the same information to many destinations using point-to-point, it must send copies of the data to each destination in turn.

A second way to transmit data from one source to many destinations is to use a multicast (point-to-multipoint) protocol, such as UDP. With multicast, a single node can send data to many destinations by making just a single broadcast on the transport service. Destinations that are interested in receiving the data listen for the messages, while the messages just pass by those destinations that are not interested or capable of receiving them. Sending messages using multicasting provides several advantages, such as a decrease in network load and ease of distributing messages to multiple destinations. However, multicasting in inherently unreliable, due to issues such as packet loss and out-of-sequence packets. Because of the increasing need to limit network traffic in today's network infrastructures and to reach multiple destinations more easily, more reliable techniques for implementing multicasting are needed.

### SUMMARY OF THE INVENTION

One form of the present invention is a network communication technique. Other forms include unique systems and methods to improve multicast message reliability.

Another form includes operating a computer system that has notification application that receives requests from clients for multicast messages over a point-to-point connection, provides a response to the client over the point-to-point connection regarding how the client should listen for the multicast messages, and improves multicast message delivery reliability by using point-to-point communication in conjunction with multicast. Another form includes operating a computer system that has a notification application that serves as a central hub for data transport between clients or components on the network, and that routes messages to clients using multicast when available and unicast when multicast is not available.

Further forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one embodiment of the present invention.

FIG. 2 is a process flow diagram for the system of FIG. 1 demonstrating the stages involved in improving multicast message reliability.

FIG. 3 is a process flow diagram for the system of FIG. 1 demonstrating the stages involved in routing messages through a notification application for forwarding to appropriate subsystems.

FIG. 4 is a process flow diagram for the system of FIG. 1 demonstrating the stages involved in switching from multicast to point-to-point communications when a certain threshold is exceeded.

### DETAILED DESCRIPTION OF SELECTED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

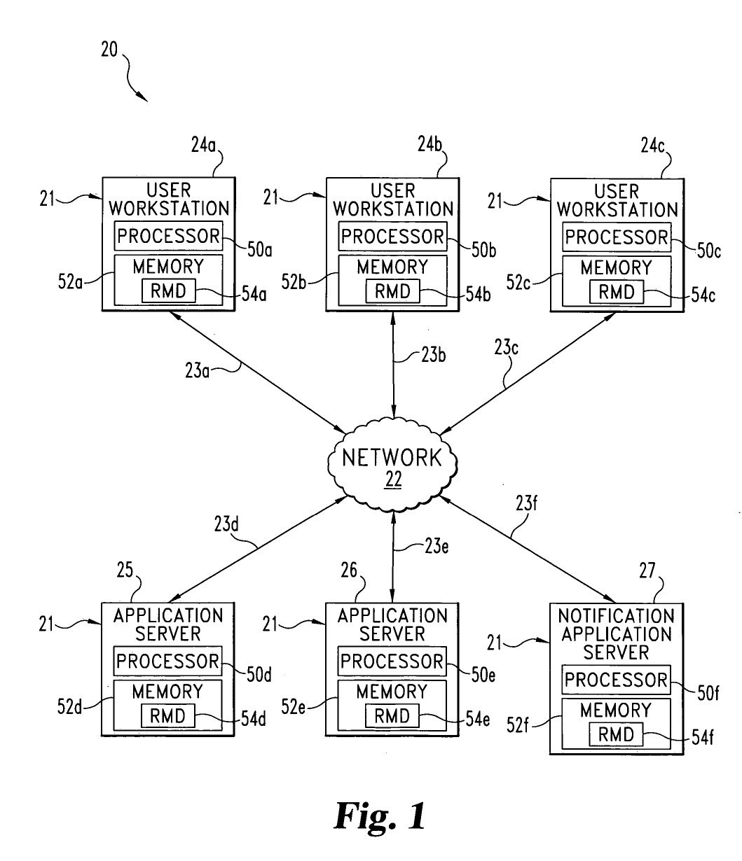

One embodiment of the present invention includes a unique message communication system. FIG. 1 is a diagrammatic view of computer system 20 of one embodiment of the present invention. Computer system 20 includes computer network 22. Computer network 22 couples together a number of computers 21 over network pathways 23. More specifically, system 20 includes several user workstations 24a, 24b, and 24c, and several servers, namely Application Servers 25 and 26, and Notification Application Server 27. While computers 21 are each illustrated as being a client or a server, it should be understood that any of computers 21 may be arranged to include both a client and server, just a server, or just a client. Furthermore, it should be understood that while six computers 21 are illustrated, more or fewer may be utilized in alternative embodiments.

User Workstations 24a, 24b, and 24c, Application Servers 25 and 26, and Notification Application Server 27 include one or more processors or CPUs (50a, 50b, 50c, 50d, 50e, and 50f, respectively) and one or more types of memory (52a, 52b, 52c, 52d, 52e, and 52f, respectively). Each memory 52a, 52b, 52c, 52d, 52e, and 52f includes a removable memory device (54a, 54b, 54c, 54d, 54e, and 54f, respectively). Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory (removable or otherwise) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD); a magnetically encoded hard disc, floppy disc, tape, or cartridge media; or a combination of any of these memory types. Also, each memory may be volatile, nonvolatile, or a hybrid combination of volatile and nonvolatile varieties.

Computer network 22 can be in the form of a Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates at one or more physical locations with user workstations 24a, 24b, and 24c used as client computers, Application Servers 25 and 26 used to host certain network applications and/or databases, and Notification Application Server 27 configured as a central hub for message transport between computers 21. Alternatively or additionally, system 20 can operate as a telephony system at one or more physical locations with Application Server 25 being configured as a call processor for telephones (not shown to preserve clarity), Application Server 26 being configured as a speech recognition processor for telephone audio, and Notification Application Server 27 configured as a central hub for message transport between computers 21. It should be understood that various other client and server arrangements are possible, such as one or more computers acting as a client, server, or both. Alternatively or additionally, system 20 may be arranged to provide for distribution and routing of a number of different forms of communication, such as telephone calls, voice mails, faxes, e-mail, web chats, web call backs, and the like.

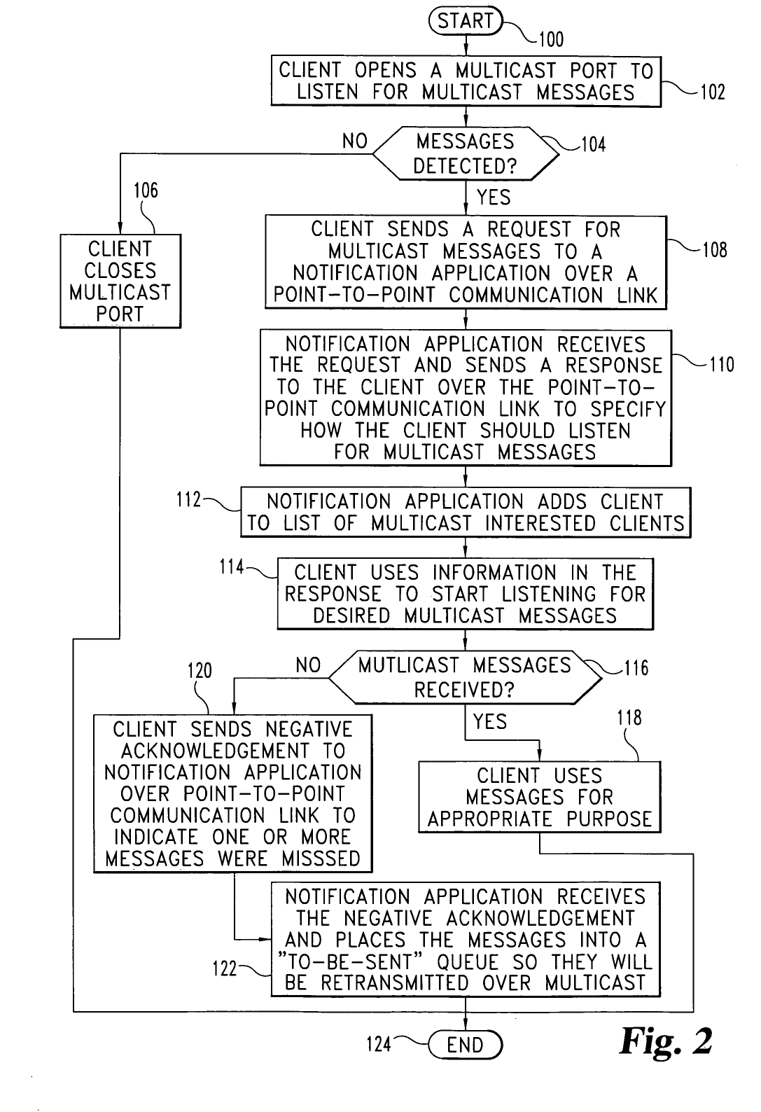

Referring additionally to FIG. 2, one embodiment for implementation with system 20 is illustrated in flow chart form as procedure 100, which demonstrates a process for improving multicast message reliability. In one form, procedure 100 is at least partially implemented in the operating logic of system 20. Procedure 100 begins with a client opening a multicast port to listen for multicast messages (stage 102). Client as used in this context can include a component, subsystem, system, or process running on any of computers 21, whether designated client computer or server computer, as a few non-limiting examples. If the presence of multicast messages is not detected after a predetermined period of time (decision point 104), then the client closes the multicast port (stage 106) and the process ends at stage 124. If multicast messages are detected (decision point 104), the client sends a request for multicast messages to a Notification Application on Notification Application Server 27 over a point-to-point communication link to indicate that the client supports and wishes to receive multicast messages (stage 108). In one embodiment, the point-to-point communication link is TCP/IP.

The Notification Application on Notification Application Server 27 receives the request for multicast messages and sends a response to the client over the point-to-point communication link to specify how the client should listen for multicast messages (stage 110). Multicast retrieval information included in the response message can include details such as sequence number(s) that the client should listen for, as one non-limiting example. Communicating the request and response messages over point-to-point in this manner helps improve the reliability of multicasting. The reason the reliability of multicasting is improved in this scenario is because a reliable transport mechanism (point-to-point) is used to communicate details about the inherently unreliable transport mechanism (multicast).

The Notification Application on Notification Application Server 27 adds the client to a list of multicast interested clients (stage 112) at some point before or after the client uses at least part of the information in the response to start listening for the desired multicast messages (stage 114).

If multicast messages are received by the client (decision point 116), the client uses the messages for the appropriate purpose (stage 118). For example, a component or subsystem on the client might use all or part of the data in the multicast message for processing or display, to name a few non-limiting examples. If one or more expected multicast messages were not received (decision point 116), then the client sends a negative acknowledgement (NAK) message to the Notification Application on Notification Application Server 27 over a point-to-point communication link to indicate that one or more messages were missed (stage 120). Sending the NAK using point-to-point also helps improve reliability of multicasting for the reasons discussed previously. The Notification Application receives the negative acknowledgement and places the messages in a queue, such as a “To Be Sent” queue, so they will be retransmitted over multicast at some appropriate time, such as immediately or for delayed sending at a later time (stage 122). The process then ends at stage 124.

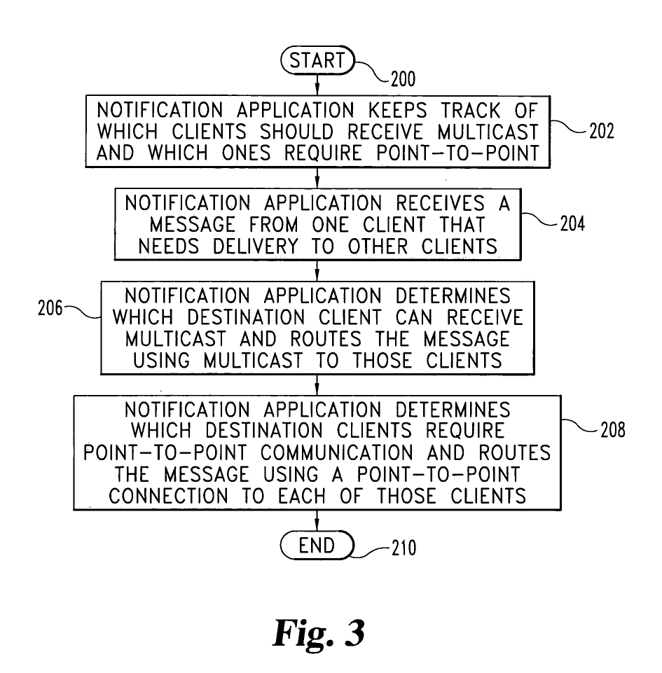

With this understanding, reference is now made to FIG. 3. In FIG. 3, another embodiment for implementation with system 20 is illustrated in flow chart form as procedure 200 for routing messages in a network through a central notification application. In one form, procedure 200 is at least partially implemented in the operating logic of system 20. Procedure 200 begins with Notification Application on Notification Application Server 27 tracking which clients should receive multicast messages and which ones require messages to be communicated by point-to-point (stage 202). When Notification Application on Notification Application Server 27 receives a message from one client that needs delivered to one or more other clients in network 22 (stage 204), Notification Application determines which destination clients, if any, can receive multicast and routes the message using multicast to those clients (stage 206), assuming the message itself supports transport by multicasting. Notification Application also determines which destination clients, if any, require point-to-point communication and then routes the message using a point-to-point connection to each of those clients (stage 208). As a few non-limiting examples, point-to-point transmission of the message may be required because the client does not support multicast or because the message itself does not support multicasting. This process can repeat as more messages arrive for delivery by the Notification Application. The process ends at stage 210.

Alternatively or additionally, one or more application components of system 20 can be implemented with interfaces that specify whether or not that message is even capable of being transmitted by multicast. As previously mentioned, just because a client is capable of receiving multicast doesn't mean the message is suitable for multicast. By implementing interfaces that specify whether the message is multicast capable, Notification Application on Notification Application Server 27 can use that as additional information for deciding whether the message is multicast capable that should then be routed to the multicast capable clients who need the message.

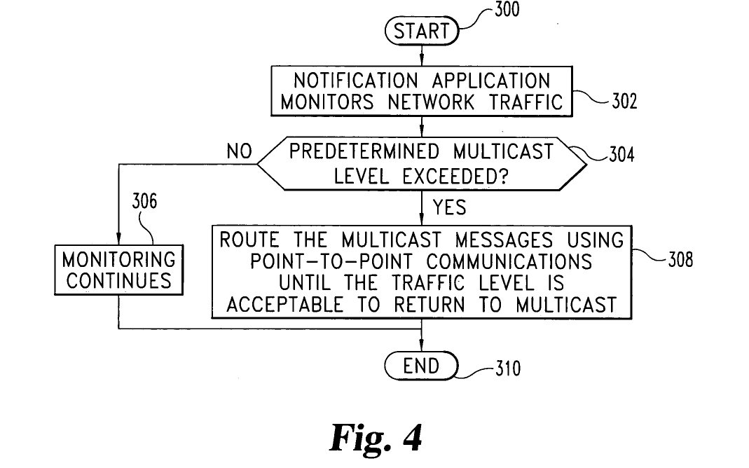

With this understanding, reference is now made to FIG. 4. In FIG. 4, another embodiment for implementation with system 20 is illustrated in flow chart form as procedure 300 for switching from multicast to point-to-point when a predetermined threshold is reached. In one form, procedure 300 is at least partially implemented in the operating logic of system 20. Procedure 300 begins with Notification Application on Notification Application Server 27 monitoring traffic on network 22 (stage 302). If a predetermined amount of multicast traffic is not exceeded (decision point 304), then monitoring continues (stage 306) and the process ends at stage 310. If a predetermined amount of multicast traffic is exceeded (decision point 304), then Notification Application sends the messages that were designated for multicast delivery instead through point-to-point links until the traffic level reaches an acceptable level for returning to multicast (stage 308). As one non-limiting example, this process can be useful to ensure that the multicast packets are not being transmitted too quickly such that a large amount of missed packets are occurring because of client buffers that are too small. The process then ends at stage 310.

In another embodiment, a method is disclosed that comprises: receiving a request for multicast messages from a first client over a point-to-point communication link with a notification application interface routine executed on a server computer; sending a response from the notification application interface routine over the point-to-point communication link to the first client, the response including multicast retrieval information; adding the first client to a list of multicast capable clients; and routing a message received from a second client to the first client using multicast.

In yet a further embodiment, a system is disclosed that comprises: a notification application interface routine executed on a server computer; a plurality of clients coupled to the notification application interface routine over a network, the clients each being operative to send messages through the notification application interface routine for delivery to a designated set of the clients; and wherein the notification application interface routine is operative to serve as a central hub for receiving and transporting messages between the clients, maintain a list of the clients supporting multicast communications, route messages using multicast to the clients supporting multicast communications, and route messages using point-to-point communications to the clients that do not support multicast communications.

In another embodiment, an apparatus is disclosed that comprises a device encoded with logic executable by one or more processors to: serve as a central hub for receiving and transporting messages between a plurality of clients, receive requests for multicast messages over point-to-point communications from at least a portion of the clients, respond to each of the requests over point-to-point communications to provide multicast retrieval information, maintain a list of the clients that requested multicast communications, route messages using multicast to the clients that requested multicast communications, and route messages using point-to-point communications to the clients that did not request multicast communications.

In yet a further embodiment, a method is disclosed that comprises: sending a request for multicast messages from a client to a notification application interface routine on a server computer over a point-to-point communication link; receiving at the client a response from the notification application interface routine over the point-to-point communication link, said response including multicast retrieval information; and listening from the client for multicast messages using at least some of the multicast retrieval information provided in the response from the notification application interface routine.

One of ordinary skill in the computer software art will appreciate that the functionality and/or components described herein can be separated or combined on one or more computers in various arrangements and still be within the spirit of the invention. While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

1. A method comprising:
receiving a request for multicast messages from a first client over a point-to-point communication link with a notification application interface routine executed on a server computer;
sending a response from the notification application interface routine over the point-to-point communication link to the first client, the response including multicast retrieval information;
adding the first client to a list of multicast capable clients; and
routing a message received from a second client to the first client using multicast.

2. The method of claim 1, further comprising:
receiving a request for a multicast message resend from the first client over the point-to-point communication link with the notification application interface routine; and
responding from the notification application routine to the resend request by resending the requested multicast message using multicast.

3. The method of claim 1, wherein the point-to-point communication link is TCP.

4. The method of claim 1, wherein the multicast retrieval information includes at least one sequence number.

5. The method of claim 1, wherein the first client is a component that forms at least part of a subsystem.

6. The method of claim 1, wherein the second client is a component that forms at least part of a subsystem.

7. A system comprising:
a notification application interface routine executed on a server computer;
a plurality of clients coupled to the notification application interface routine over a network, the clients each being operative to send messages through the notification application interface routine for delivery to a designated set of the clients; and
wherein the notification application interface routine is operative to serve as a central hub for receiving and transporting messages between the clients, maintain a list of the clients supporting multicast communications, route messages using multicast to the clients supporting multicast communications, and route messages using point-to-point communications to the clients that do not support multicast communications.

8. The system of claim 7, wherein the notification application interface routine is further operative to receive a multicast message request from a specified one of the clients over a point-to-point communication link and send a multicast message response to the specified one of the clients over the point-to-point communication link, said response including information about how the specified one of the clients should listen for multicast messages; and wherein after receiving the multicast message request the notification application interface routine adds the specified one of the clients to the list of the clients that can support multicast communications.

9. The system of claim 8, wherein the notification application interface routine is further operative to receive a request over the point-to-point communication link for a multicast message resend from the specified one of the clients and respond to the resend request by resending the requested multicast message using multicast.

10. The system of claim 9, wherein upon receiving a multicast message resend request, the notification application interface routine places the requested message in a queue for later delivery.

11. The system of claim 7, wherein the clients are components that each form a portion of one or more applications.

12. The system of claim 7, wherein the notification application interface routine is further operative to monitor a level of traffic on the network and when the traffic level for multicast communications exceeds a predetermined traffic level, route the multicast messages using point-to-point communications until the traffic level is reduced to an acceptable level.

13. An apparatus comprising: a device encoded with logic executable by one or more processors to: serve as a central hub for receiving and transporting messages between a plurality of clients, receive requests for multicast messages over point-to-point communications from at least a portion of the clients, respond to each of the requests over point-to-point communications to provide multicast retrieval information, maintain a list of the clients that requested multicast communications, route messages using multicast to the clients that requested multicast communications, and route messages using point-to-point communications to the clients that did not request multicast communications.

14. The apparatus of claim 13, wherein the device includes a removable memory device carrying a number of processor executable instructions to define the logic.

15. The apparatus of claim 14, wherein the removable memory device includes a disk.

16. The apparatus of claim 13, wherein the device is in the form of one or more parts of a computer network carrying one or more signals encoding the logic.

17. A method comprising:
sending a request for multicast messages from a client to a notification application interface routine on a server computer over a point-to-point communication link;
receiving at the client a response from the notification application interface routine over the point-to-point communication link, said response including multicast retrieval information; and
listening from the client for multicast messages using at least some of the multicast retrieval information provided in the response from the notification application interface routine.

18. The method of claim 17, further comprising:
prior to sending a request for multicast messages, opening a multicast port from the client to confirm the presence of multicast messages.

19. The method of claim 17, wherein the point-to-point communication link is TCP.

20. The method of claim 17, wherein the multicast retrieval information includes at least one sequence number.

21. The method of claim 17, wherein the client is a component that forms at least part of a subsystem.

22. The method of claim 17, further comprising:
determining at the client that one or more desired multicast messages were not received; and
sending a negative acknowledgement message from the client over the point-to-point communication link to the notification application interface routine to request that the one or more desired multicast messages be resent.
